(19) United States
(12) Patent Application Publication
(10) Pub. No.: US 2014/0068744 A1
(43) Pub. Date: Mar. 6, 2014

(54) Surrogate Secure Pairing of Devices

(71) Applicants: Cary Bran, Seattle, WA (US); Shantanu Sarkar, San Jose, CA (US); Joe Burton, Los Gatos, CA (US); Joseph Stachula, Santa Cruz, CA (US)

(72) Inventors: Cary Bran, Seattle, WA (US); Shantanu Sarkar, San Jose, CA (US); Joe Burton, Los Gatos, CA (US); Joseph Stachula, Santa Cruz, CA (US)

(73) Assignee: PLANTRONICS, INC., Santa Cruz, CA (US)

(21) Appl. No.: 13/604,902

(22) Filed: Sep. 6, 2012

(51) Int. Cl. G06F 21/00

(52) U.S. Cl. 726/9

(57) ABSTRACT

Methods and apparatuses for secure pairing are disclosed. In one example, a pairing surrogate is utilized to issue a pairing token to a first device and a second device to be paired.

### BACKGROUND OF THE INVENTION

Bluetooth is a wireless technology standard for exchanging data over short distances using short-wavelength radio transmissions in the ISM band from 2400-2480 MHz from fixed and mobile devices. Bluetooth uses a process called pairing to control which devices are allowed to connect to a given Bluetooth device and establish a connection without user intervention (e.g., as soon as the devices are in range). The pairing process is triggered either by a specific request from a user to pair devices, or it is triggered automatically when connecting to a service for the first time where the identity of a device is required.

Pairing typically involves some level of user interaction to confirm the identity of the devices. Once pairing successfully completes, a bond will have been formed between the two devices, enabling the two paired devices to connect to each other in the future without repeating the pairing process.

During the Bluetooth pairing process, the two devices involved establish a relationship by creating a link key (also referred to herein as a security “token”) which is shared and stored on both devices. If a link key is stored by both devices, the devices are said to be paired. The link key is then exchanged in all subsequent transactions. A device that wants to communicate only with a paired device can cryptographically authenticate the identity of the other device to ensure it is the same device it previously paired with. Once a link key has been generated, an authenticated Asynchronous Connection-Less (ACL) link between the devices may be encrypted so that any data exchanged is protected against eavesdropping.

One common form of the link key is a PIN code, which may be an ASCII string up to 16 characters in length, for example. If a fixed PIN is associated with a first device, a user of the second device may enter the PIN code associated with the first device into the second device. Upon receiving the correct PIN code, the second device is able to successfully authenticate the first device and the devices establish a communication link, in order to complete the Bluetooth pairing.

Many devices employ a simple numeric PIN code, such as a 4-digit PIN code for example, which is frequently fixed in memory at the device (e.g., “0000”). In particular, devices such as headsets that have a limited user interface are likely to have fixed PIN codes. With little or no user interface, devices that use a randomly generated pairing code become very cumbersome as there is no way to relay the code to the user. However, while the “0000” approach works for users/environments where secure device pairing is not important, it is problematic in environments where security is important.

Other Bluetooth devices may utilize the Secure Simple Pairing (SSP) process described in the Bluetooth Specification Revision 2.1, which is hereby incorporated by reference in its entirety. In particular, devices having a limited user interface often employ a simplified version of the “Numeric Comparison” pairing Association Model, where the simplified version is often referred to as “Just Works” pairing. In the “Numeric Comparison” model, both devices to be paired calculate a random six digit user confirmation value that only the devices know and both devices display the number on each device screen. The user compares the displayed numbers to ensure they match and presses a button on each device to confirm. Devices with a limited user interface not having a display may utilize the “Just Works” simplification, whereby user confirmation is assumed and pairing is performed without actual user confirmation of the calculated six digit number. Again, while the “Just Works” approach works for users/environments where secure device pairing is not important, it is problematic in environments where security is important.

Bluetooth security attacks include eavesdropping, unauthorized device control, unauthorized access to personal data, denial of service, and identity detection Bluetooth devices may be subject to “Man-in-the-Middle” attacks, whereby an unauthorized device insinuates itself in the pairing process between two legitimate devices. The unauthorized device responds to both legitimate devices during the pairing process, fooling the legitimate devices into believing they have located each other. Instead, the legitimate devices are communicating with and through the unauthorized device, enabling the unauthorized device full trust of both devices. The unauthorized device is thus enabled to eavesdrop on communications and take control of the legitimate devices. Bluetooth headsets in particular are vulnerable to compromised telephony commands which hijack the functions and content of an associated mobile phone as well as compromised voice conversations.

As a result, improved methods and apparatuses for pairing of wireless devices are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a system for secure pairing of a first electronic device with a second electronic device in one example.

FIG. 2 illustrates a detailed view of the system shown in FIG. 1 in one example.

FIG. 4 is a flow diagram illustrating pairing of a first electronic device with a second electronic device in one example.

FIGS. 4A-4H are diagrams illustrating a pairing process for electronic devices.

### DESCRIPTION OF SPECIFIC EMBODIMENTS

Methods and apparatuses for device pairing are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

This invention relates to secure device pairing. In one example, the inventors have identified that it is advantageous to authenticate the user as part of the pairing process. In one example, a method for secure pairing of a first electronic device with second electronic device includes receiving at a surrogate device a request to pair a first electronic device with a second electronic device. The method includes establishing an identity of a user transmitting the request. The method further includes generating a pairing token and issuing the pairing token to the first electronic device and the second electronic device.

In one example, a computer readable storage memory storing instructions that when executed by a computer cause the computer to perform a method for identity secure device pairing. The method includes receiving a request to pair a first electronic device with a second electronic device and confirming an identity of a user authorized to use the first electronic device and the second electronic device. The method further includes issuing an identity secure pairing authentication token operable to pair the first electronic device and the second electronic device for wireless communications responsive to confirming the identity of the user.

In one example, an apparatus for secure pairing of a first electronic device with a second electronic device includes a processor and an interface configured to receive a request to pair a first electronic device with a second electronic device. The apparatus includes an identity verification module operable to establish an identity of a user. The apparatus further includes an authorization provider module configured to issue a pairing token to the first electronic device and the second electronic device responsive to the request and establishing the identity of the user.

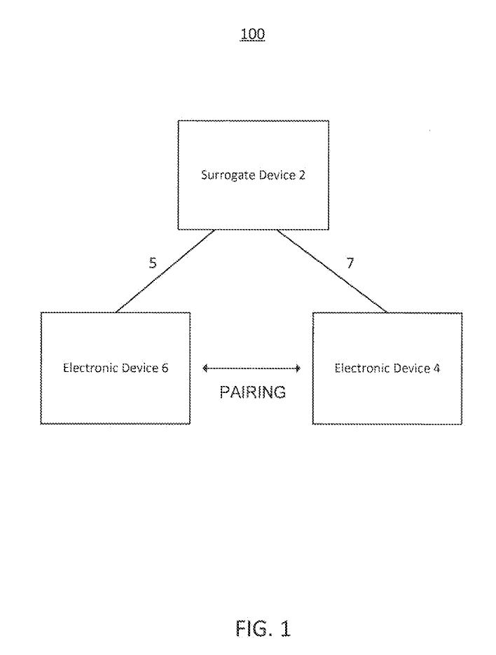

FIG. 1 illustrates a system 100 for secure pairing of a first electronic device 4 with a second electronic device 6 in one example. Illustrated in FIG. 1 is a system in which a pairing token (also referred to herein as an authorization token or link key) for wireless device pairing is issued from a surrogate device 2 to the first electronic device 4 and the second electronic device 6 over a communications link 7 and communications link 5, respectively. In one example, communications link 7 and communications link 5 are a wireless interface link. In a further example, communications link 7 and communications link 5 are a wired interface link.

In the example a system 100 includes a surrogate device 2, and electronic device 4 and electronic device 6 to he paired for wireless communications. Electronic device 4 and electronic device 6 are devices to which the surrogate device 2 issues a pairing token. In certain examples, the surrogate device makes the decision to grant or reject the request for authorization tokens at least partly based on authentication of a user (e.g., confirmation of the user identity) of the devices. If the user is an authorized user, the request is granted. On the other hand, if the user is not authorized, the request is rejected. Authentication of the user can be performed by different methods as described in further detail herein. In certain embodiments, the issued pairing token has an expiration time. After the token expires, to establish communications between electronic device 4 and electronic device 6, the pairing process must be repeated so that a new pairing token is issued.

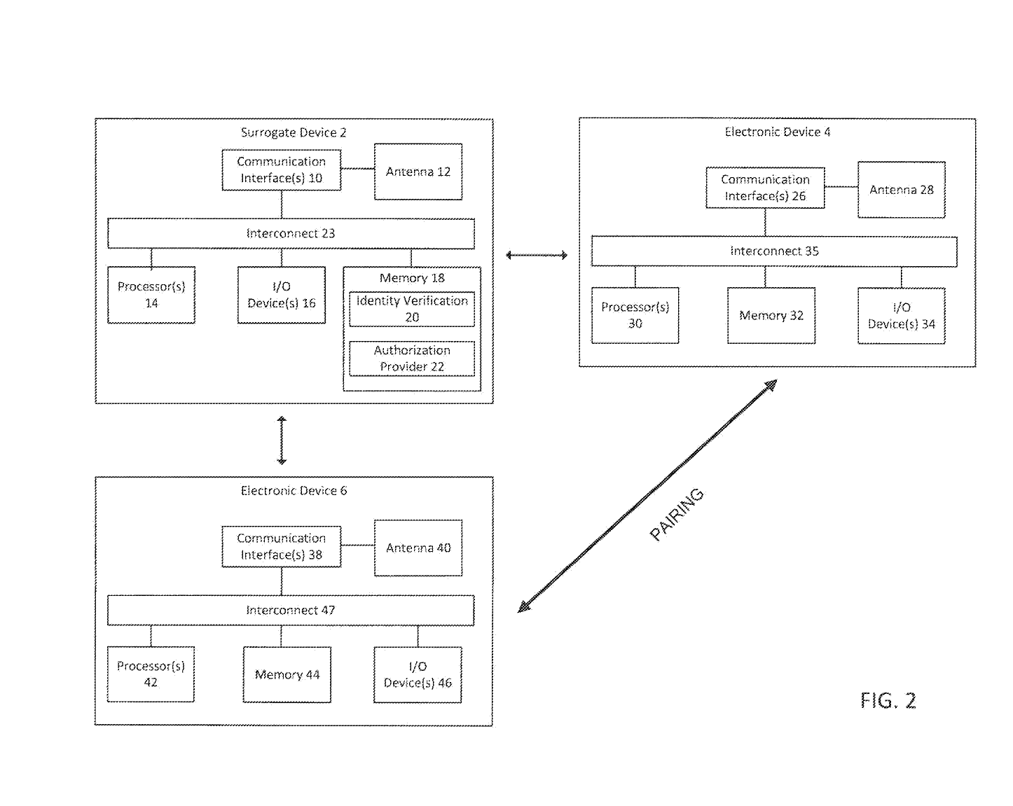

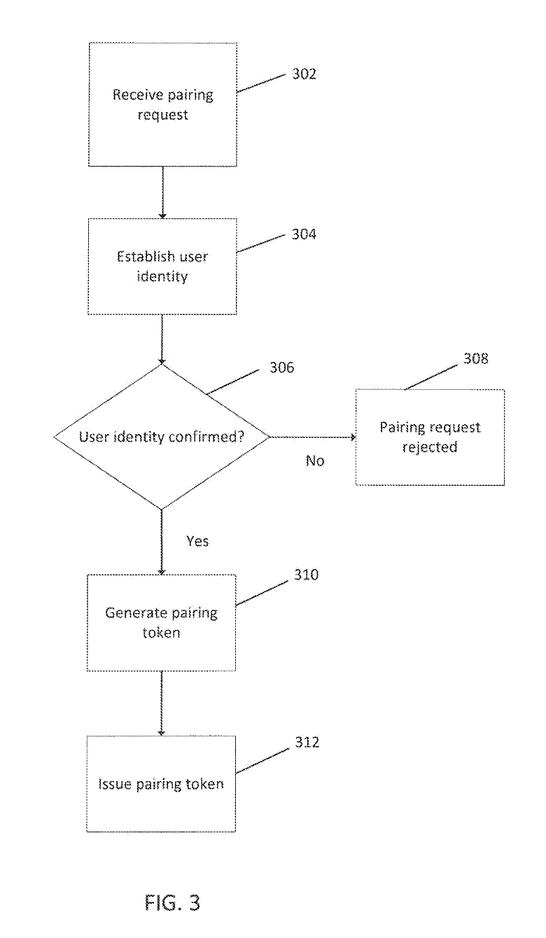

FIG. 2 illustrates a detailed view of the system shown in FIG. 1 in one example. Simplified block diagrams of the surrogate device 2, an electronic device 4, and an electronic device 6 are provided in FIG. 2. In one example, the surrogate device 2, the electronic device 4, and electronic device 6 each include a two-way RF communication device having data communication capabilities. Each of the surrogate device 2, electronic device 4, and electronic device 6 has the capability to communicate with other computer systems via a local or wide area network.

The surrogate device 2 includes a processor 14 configured to execute code stored in a memory 18. Processor 14 executes an identity verification (also referred to herein as “user authentication”) module 20 and authorization provider module 22 to perform functions described herein. Identity verification module 20 is operable to establish an identity of a user. In one example, the identity verification module 20 utilizes a password operable to receive biometric data.

Authorization provider module 22 is configured to issue pairing token to the electronic device 4 and the electronic device 6 responsive to the request and establishing the identity of the user. In one example, the pairing token is transmitted to the electronic device 4 and the electronic device 6 utilizing a near field communications protocol. In one example, the pairing token is configured with an expiration parameter such a date and time at which the token expires. In one example, the pairing token is operable to pair the electronic device 4 and the electronic device 6 for Bluetooth communications.

In one example, the authorization provider module 22 is further configured to confirm an electronic device 4 certification authority (CA) certificate and an electron device 6 certification authority certificate prior to issuing the pairing token. The CA certificates are encrypted certificates that use public/private key ciphers and are traceable to a trusted root source.

While only a single processor 14 is shown, surrogate device 2 may include multiple processors and/or co-processors, or one or more processors having multiple cores. The processor 14 and memory 18 may be provided on a single application-specific integrated circuit, or the processor 14 and the memory 18 may be provided in separate integrated circuits or other circuits configured to provide functionality for executing program instructions and storing program instructions and other data, respectively. Memory 18 also may be used to store temporary variables or other intermediate information during execution of instructions by processor 14.

Surrogate device 2 includes communication interface(s) 10, one or more of which may utilize an antenna 12. The communications interface(s) 10 may also include other processing means, such as a digital signal processor and local oscillators. In one example, communications interface(s) 10 include one or more short-range wireless communications subsystems which provide communication between surrogate device 2 and different systems or devices. For example, the short-range communications subsystem may include an infrared device and associated circuit components for short-range communication, a near field communications (NFC) subsystem, a Bluetooth subsystem, or a WiFi subsystem. Interconnect 23 may communicate information between the various components of surrogate device 2.

Surrogate device 2 also includes input/output (I/O) device(s) 16 configured to interface with the user. I/O device(s) 16 include one or more input devices, such as a keyboard, microphone, etc., and one or more output devices, such as a display, speaker, etc. In some embodiments, I/O device(s) 16 may include or more of a display device, such as a liquid crystal display (LCD), an alphanumeric input device, such as a keyboard, and/or a cursor control device, and a biometric input device. A user request to pair electronic device 4 and electronic device 6 may be received at an I/O device 16,

I/O device(s) 16 may consist of a variety of devices which can be used to establish or authenticate the identity of a user. Users authenticate themselves using passwords, ID-cards and/or biometrics to the authentication system through one or more I/O device(s) 16. Input is used to receive passwords and/or biometric data or read ID-cards. Output may display menu prompts. Examples of an authentication system using I/O device(s) 16 are a user entering a password using a keyboard to access the authorization provider. I/O device(s) 16 may include a device that performs biometric sensing. Examples of biometrics are voice authentication (requiring a microphone I/O device 16) and fingerprint reading (requiring a finger scanner I/O device 16).

Memory 18 may include both volatile and non-volatile memory such as random access memory (RAM) and read-only memory (ROM). User authentication information, including personal identification numbers (PINs) or biometric data may be stored in memory 18.

Instructions may be provided to memory 18 from a storage device, such as a magnetic device, read-only memory, via a remote connection (e.g., over a network via communication interface(s) 10) that may be either wireless or wired providing access to one or more electronically accessible media. In alternative examples, hard-wired circuitry may be used in place of or in combination with software instructions, and execution of sequences of instructions is not limited to any specific combination of hardware circuitry and software instructions.

Surrogate device 2 may include operating system code and specific applications code, which may be stored in non-volatile memory. For example the code may include drivers for the surrogate device 2 and code for managing the drivers and a protocol stack for communicating with the communications interface(s) 10 which may include a receiver and a transmitter and is connected to an antenna 12. Communication interface(s) 10 may provide a wired interface or wireless interface for communication with electronic device 4 and electronic device 6.

Communication interface(s) 10 may provide access to a network, such as a local area network. Communication interface(s) 10 may include, for example, a wireless network interface having antenna 12, which may represent one or more antenna(e). In one embodiment, communication interface(s) 10 may provide access to a local area network, for example, by conforming to IEEE 802.11b and/or IEEE 802.11 g standards, and/or the wireless network interface may provide access to a personal area network, for example, by conforming to Bluetooth standards. In addition to, or instead of, communication via wireless LAN standards, communication interface(s) 10 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

The electronic device 4 includes an interconnect 35 to transfer data and a processor 30 is coupled to interconnect 35 to process data. Electronic device 4 includes communication interface(s) 26, antenna 28, memory 32, and I/O device(s) 34. The processor 30 may execute a number of applications that control basic operations, such as data and voice communications via the communication interface(s) 26.

Similarly, the electronic device 6 includes an interconnect 47 to transfer data and a processor 42 is coupled to interconnect 47 to process data. Electronic device 6 includes communication interface(s) 38, antenna 40, memory 44, and I/O device(s) 46. The processor 42 may execute a number of applications that control basic operations, such as data and voice communications via the communication interface(s) 38.

In various embodiments, the technique of FIG. 3 discussed below may be implemented as sequences of instructions executed by e or more electronic systems. The instructions may be stored by the surrogate device 2 or the instructions may be received by the surrogate device 2 (e.g., viva network connection).

Surrogate device 2, electronic device 4 and electronic device 6 are intended to represent a range of electronic devices, for example, headsets, computer systems, tablet computers, smartphones, laptops, PDAs, cellular telephones, etc. In certain cases, such as where electronic device 4 or electronic device 6 is a wireless headset, the device may have a limited user interface (e.g., no display or reduced user input buttons). In one example, electronic device 4 and electronic device 6 are Bluetooth enabled devices such as headsets, smartphones, or tablet computers. In one example, surrogate device 2 is a personal computer such as a desktop computer or laptop computer, a smartphone, or a tablet computer.

The specific design and implementation of the communications interfaces of the surrogate device 2, the electronic device 4, and the electronic device 6 are dependent upon the communication networks in which the devices are intended to operate. In one example, surrogate device 2 communicates with electronic device 4 and electronic device using a first communication interface utilizing a short range wireless communications protocol or a wired link, and electronic device 4 and electronic device 6 communicate with each other using a second communication interface in accordance with the Bluetooth standard. To communicate with each other utilizing Bluetooth, electronic device 4 and electronic device 6 must be paired by receiving and using a pairing token from surrogate device 2.

In operation, if a user wishes to utilize wireless communications between electronic device 4 and electronic device 6 and the devices have not been issued pairing tokens or the pairing tokens have expired, a wireless connection pairing process is performed. In the preferred embodiment, the surrogate device 2 prompts the user to authenticate his or her identity. The prompt may be displayed in response to a user action, for example by requesting that the electronic device 4 and electronic device 6 be paired.

The user may authenticate his or her identity in one of several ways, depending upon the system configuration. For example, the surrogate device 2 may prompt the user to enter a user name and password. Once the user identity is authenticated, the surrogate device 2 issues a pairing token to both electronic device 4 and electronic device 6. The pairing token is therefore identity secured. In one example of a Bluetooth embodiment, the pairing token stored on electronic device 4 and electronic device 6 operates as a Bluetooth link key. The pairing token is used in encrypting subsequent communications between electronic device 4 and electronic device 6.

In one example, the pairing token may include a MAC address or device identifier, and can include a hash of a device's public key. In one Bluetooth example, the surrogate device 2 receives the public keys of the electronic device 4 and electronic device 6 and calculates a Diffie Hellman Key (DHKey). The pairing token is then calculated from the DHKey.

In a further example, one or more additional steps may be utilized to pair electronic device 4 and electronic device 6. For example, in a Bluetooth embodiment, a Secure Simple Pairing (SSP) process may be performed, whereby a Pass Key Entry, Out-Of-Bounds, Numeric Comparison, or “Just Works” Association Model is employed. In a further example, a PIN code is employed, which may be an ASCII string up to 16 characters in length.

In one example, authorization provider module 22 in conjunction with identity verification module 20 does the following with respect to the authentication state of the user: (1) takes in user specific data (password, card ID, or biometrics hereafter called “credentials”), (2) analyzes credentials and determines authentication status, (3) records when a successful or failed authentication occurs, (4) monitors authentication expiration time for a given user, (5) revokes authentication under specified conditions or events, and (6) provides a cookie/ticket/certificate/key, which are typically small amounts of digital data (i.e., “digital credentials”) to an authenticator (a website server for example) or user agent (browser software for example).

Authorization provider module 22 in conjunction with identity verification module 20 operates to examine user/password data token information or biometric data, and generates digital credentials based on this data. The authorization provider module 22 has shared data or a database for its users and compares the digital credentials received to its data.

In one example, a personal computer surrogate device 2 has a log-on software subsystem dedicated to authenticating the user, and software subsystems which check the status before proceeding. The user and surrogate device 2 follow a protocol to authenticate the user. There are many authentication protocols in existence and/or being developed.

FIG. 3 is a flow diagram illustrating pairing of a first electronic device with a second electronic device in one example. In one example, the underlying protocol can be Bluetooth. In one example, the first electronic device or second electronic device is a wireless headset and the surrogate device is a personal computer or a mobile phone.

At block 302, a pairing request is received. At block 304, the user identity of the user requesting the pairing is established. In one example, establishing an identity of a user comprises receiving a user name and a user password.

At decision block 306, it is determined whether the user identity is confirmed. Establishment and confirmation of the user identity (i.e., user authentication) can be performed utilizing methods described herein. If no at decision block 306, at block 308 the pairing request is rejected. If yes at decision block 306, at block 310, a pairing token is generated. In one example, the pairing token is configured with an expiration parameter such that the token is valid only for a specified amount of time before it expires (i.e., becomes invalid).

At block 312, the pairing token is issued to the first electronic device and the second electronic device. In a Bluetooth example, the pairing token is operable to pair the first electronic device and the second electronic device for Bluetooth communications. In one example, a first electronic device certification authority certificate and a second electronic device certification authority certificate are confirmed prior to issuing the pairing token. In one example, issuing the pairing token to the first electronic device and the second electronic device includes transmitting the pairing token utilizing, a near field communications protocol.

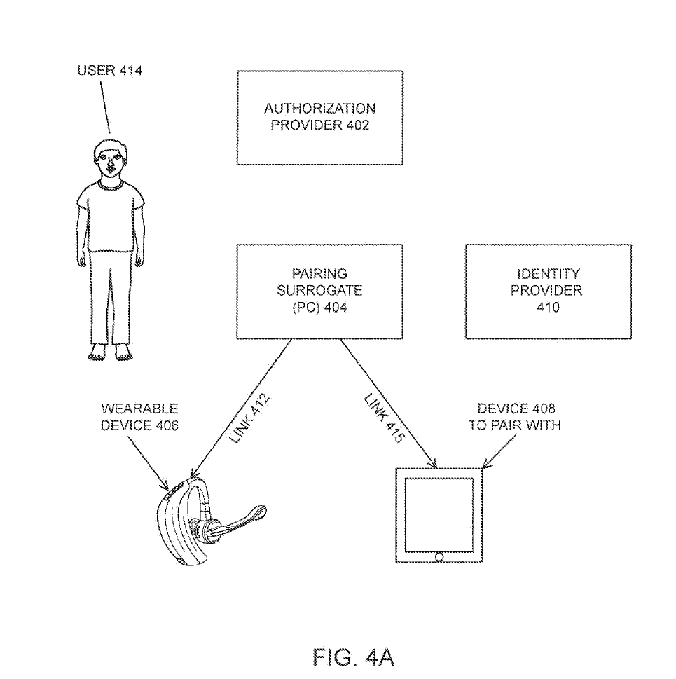

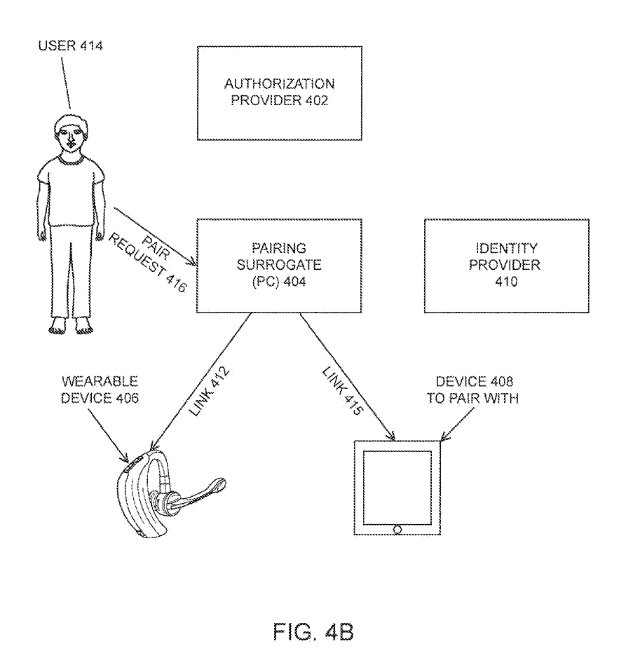

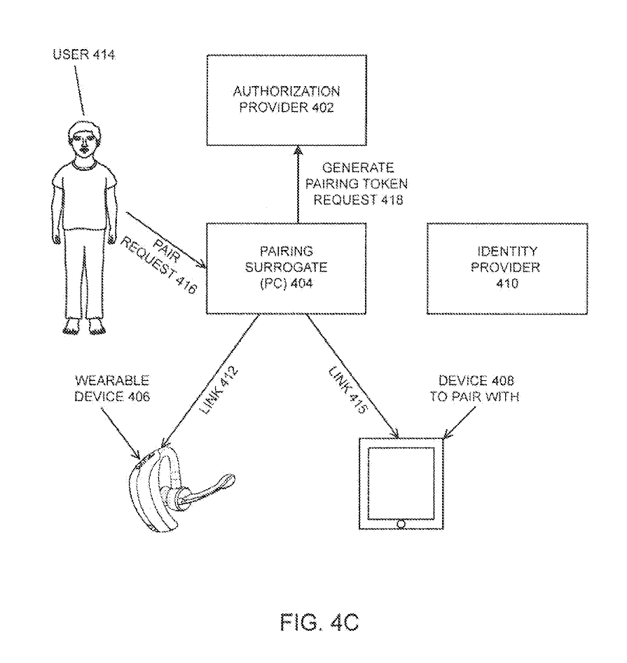

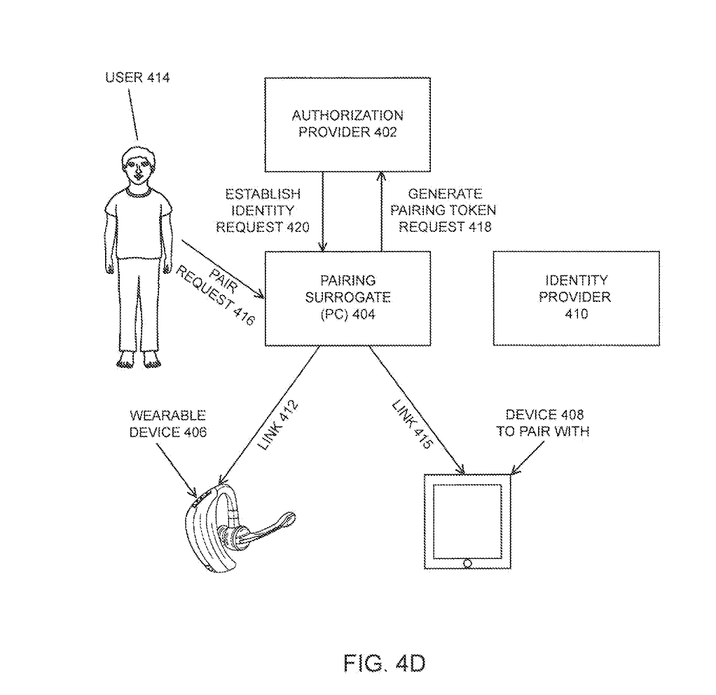

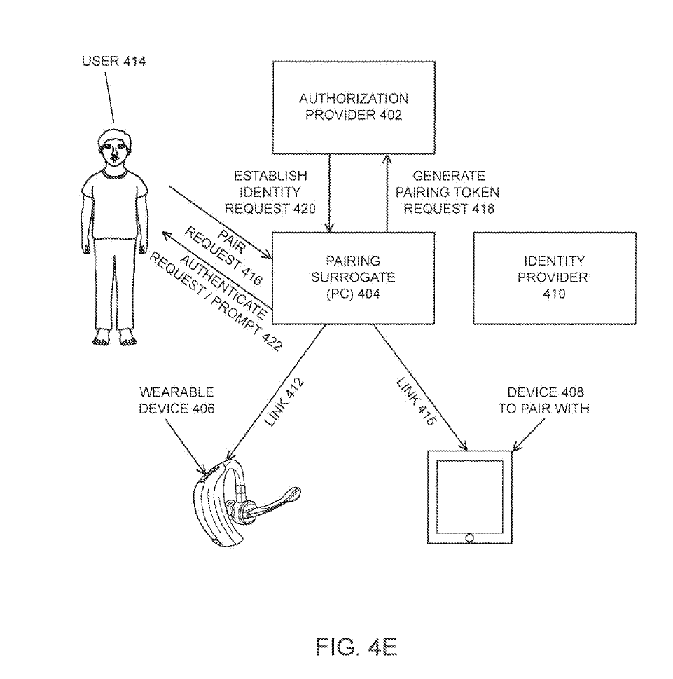

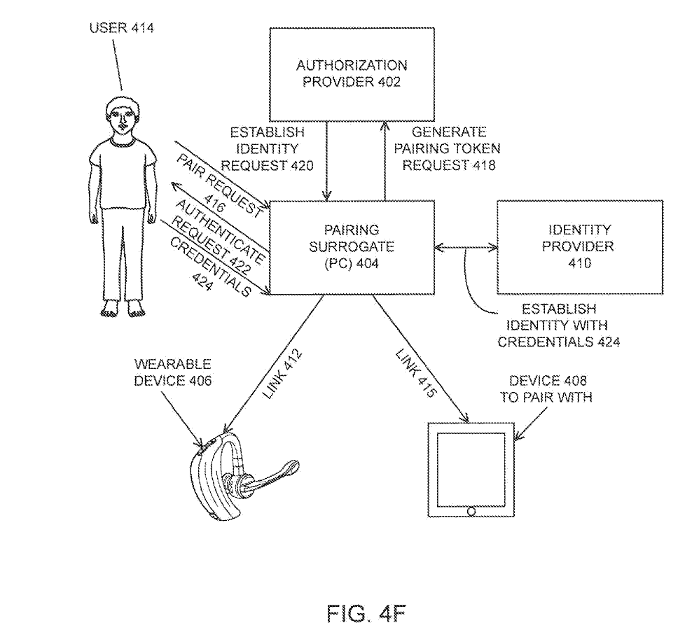

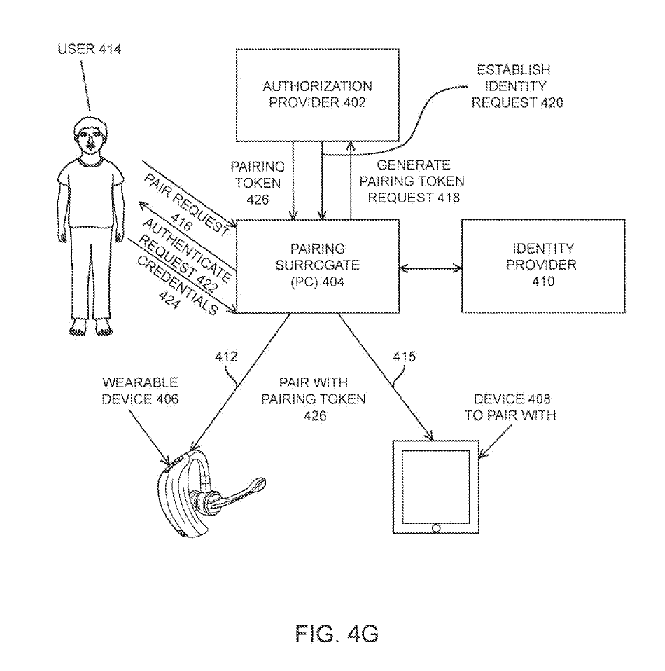

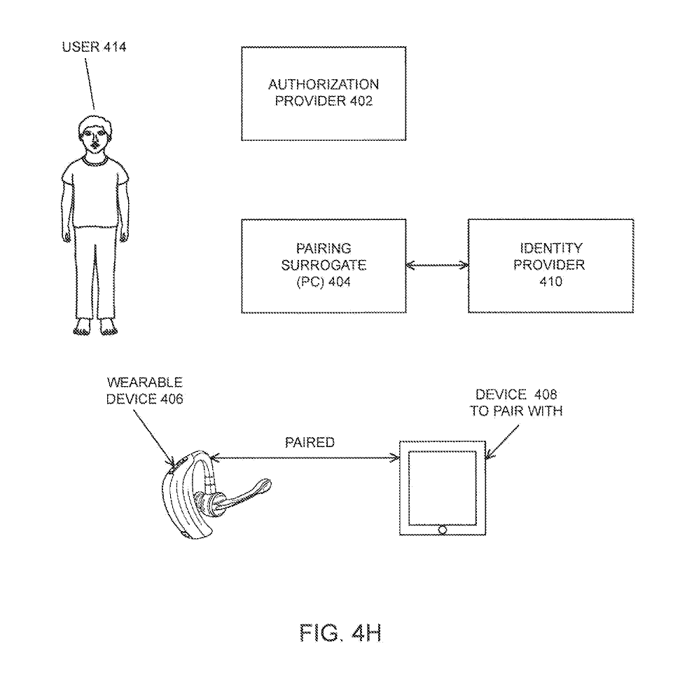

FIGS. 4A-4H are diagrams illustrating a pairing process for electronic devices in one example embodiment. To deliver a secure pairing solution, a pairing surrogate is used to securely pair one or more devices together. In this example, the system elements include an identity provider 410 responsible for establishing the identity of a user 414. Possible embodiments of the identify provider 410 include a simple username/password provider, biometric readers such as a palm-print or finger-print reader, or a voice verification system. An authorization provider 402 is responsible for issuing the pairing token (also referred to as a “key”). In one example, the pairing token is a time-bound construct that is used to pair the devices together for a specified amount of time. A pairing surrogate 404 is the responsible for pairing the devices securely. It communicates with the user 414 and the identity provider 410 and authorization provider 402 to generate a securely paired device. Although shown as separate functional blocks from pairing surrogate 404, authorization provider 402 and identity provider 410 functionality and/or components may reside on pairing surrogate 404 in various examples. The system includes a wearable device 406 and a device 408 to be paired.

As shown in FIG. 4A, a wearable device 406 in one example is a headset and a device 408 to be paired is a tablet type computer. In this example, only an authorized user 414 of the tablet device 408 is authorized to pair wearable device 406 with device 408. In one example, only devices authorized by the authorized user's company can be paired.

To pair wearable device 406 and device 408, the user 414 has a pairing surrogate implementation on his desktop PC (i.e., pairing surrogate 404). In this embodiment, the user's devices 406, 408 use a short range communications link such as NFC to communicate with the pairing surrogate 404 over link 412 and link 415. In other embodiments the devices 406, 408 are physically connected to the surrogate with a cable. Regardless of the implementation, the devices 406, 408 to be paired are within close physical proximity of the pairing surrogate 404. This close proximity, or connected state to the pairing surrogate 404 is done to guard against unauthorized device pairing. Advantageously, multiple devices may be paired at the same time.

In another embodiment, each device wishing to be paired contains a company issued CA certificate. Only devices connected to the pairing surrogate 404 with the CA certificate would be paired. This prevents any outside devices not authorized by the company from being brought in and paired with a secure device.

When the devices 406, 408 are connected to the pairing surrogate 404, the user 414 will see a prompt asking if he/she desires to pair the devices. Because the user 414 wants to pair the devices, the user 414 will ask the surrogate to begin the pairing process by submitting pair request 416 as shown in FIG. 4B.

As shown in FIG. 4C, following reception of the pairing request 416, the pairing surrogate 404 interacts with the authorization provider 402 by submitting a generate pairing token request 418, which operates to request the authorization provider 402 generate a secure pairing token.

As shown in FIG. 4D, since the user 414 has not yet identified himself or herself to the authorization provider 402, the authorization provider 402 issues an establish identity request 420 to the pairing surrogate 404. As shown in FIG. 4E, the pairing surrogate 404 issues an authenticate request/prompt 422 to the user 414 prompting the user 414 to establish his identity with the pairing surrogate 404.

As shown in FIG. 4F, the user 414 establishes his or her identity with the identity provider 410. Credentials 424 are submitted by user 414 to pairing surrogate 404, which interacts with identity provider 410 to establish the user identity utilizing credentials 424. In this embodiment, the identity provider 410 is a simple username/password identity provider, but in further example, more sophisticated authentication mechanisms such as biometrics are utilized. The identity provider 410 establishes the identity of the user 414.

As shown in FIG. 4G, once the identity of user 414 has been established, the pairing surrogate 404 will pass an identity key to the authorization provider 402. The authorization provider 402 will generate the pairing token 426 and issue it to pairing surrogate 404 for transmission to devices 406, 408. The pairing token 426 generated by the authorization provider 402 is configurable. Some possible configurations could be cipher suite required, expiration time (hours, minutes, days, never, etc . . . ), and expire on disconnect. With the pairing token 426 created, the pairing surrogate 404 will in this embodiment prompt the user 414 asking which devices he or she wishes to pair. The devices 406, 408 will pair and will respect the settings on the pairing token 426.

Referring to FIG. 4H, once the devices 406, 408 are paired, the pairing will remain intact as specified by the pairing token 426. Once the pairing token 426 has become invalidated, the devices 406, 408 will have to be repaired with each other using the pairing surrogate 404. Advantageously, by requiring the use of pairing surrogate 404 and a time-bound pairing token, the described methods and apparatuses provide improved secure pairing implementations.

While the exemplary embodiments of the present invention are described and illustrated herein, it will be appreciated that they are merely illustrative and that modifications can be made to these embodiments without departing from the spirit and scope of the invention. For example, while the Bluetooth wireless communications protocol is discussed in various examples, the apparatuses and methods described herein may be utilized with other wireless protocols in when device identity confirmation is required. Thus, the scope of the invention is intended to be defined only in terms of the following claims as may be amended, with each claim being expressly incorporated into this Description of Specific Embodiments as an embodiment of the invention.

What is claimed is:

1. A method for secure pairing of a first electronic device with a second electronic device comprising:
receiving at a surrogate device a request to pair a first electronic device with a second electronic device;
establishing an identity of a user transmitting the request;
generating a pairing token; and
issuing the pairing token to the first electronic device and the second electronic device.

2. The method of claim 1, further comprising configuring the pairing token with an expiration parameter.

3. The method of claim 1, wherein establishing an identity of a user comprises receiving a user name and a user password.

4. The method of claim 1, wherein establishing an identity of a user comprises receiving biometric data from the user.

5. The method of claim 1, wherein the pairing token is time-bound.

6. The method of claim 1, wherein the first electronic device or second electronic device is a wireless headset and the surrogate device is a personal computer or a mobile phone.

7. The method of claim 1, wherein the first electronic device is a wireless headset and the second electronic device is a tablet computer.

8. The method of claim 1, wherein issuing the pairing token to the first electronic device and the second electronic device comprises transmitting the pairing token utilizing a near field communications protocol.

9. The method of claim 1, further comprising confirming a first electronic device certification authority certificate and a second electronic device certification authority certificate prior to issuing the pairing token.

10. The method of claim 1, wherein the pairing token is operable to pair the first electronic device and the second electronic device for Bluetooth communications.

11. A computer readable storage memory storing instructions that when executed by a computer cause the computer to perform a method for identity secure device pairing comprising:
receiving a request to pair a first electronic device with a second electronic device;
confirming an identity of a user authorized to use the first electronic device and the second electronic device; and
issuing an identity secure pairing authentication token operable to pair the first electronic device and the second electronic device for wireless communications responsive to confirming the identity of the user.

12. The computer readable storage memory of claim 11, wherein the identity secure pairing authentication token is configured with an expiration parameter.

13. The computer readable storage memory of claim 11, wherein confirming an identity of an authorized user comprises receiving a user name and a user password or receiving biometric data from the user.

14. The computer readable storage memory of claim 11, wherein the first electronic device or the second electronic device is a wireless headset.

15. The computer readable storage memory of claim 11, wherein issuing an identity secure pairing authentication token operable to pair the first electronic device and the second electronic device for wireless communications enables Bluetooth communications.

16. An apparatus for secure pairing of a first electronic device with a second electronic device comprising:
a processor;
an interface configured to receive a request to pair a first electronic device with a second electronic device;
an identity verification module operable to establish an identity of a user; and
an authorization provider module configured to issue a pairing token to the first electronic device and the second electronic device responsive to the request and establishing the identity of the user.

17. The apparatus of claim 16, wherein the pairing token is configured with an expiration parameter.

18. The apparatus of claim 16, wherein the identity verification module utilizes a password or is operable to receive biometric data.

19. The apparatus of claim 16, wherein the first electronic device of the second electronic device is a wireless headset.

20. The apparatus of claim 16, wherein the pairing token is transmitted to the first electronic device and the second electronic device utilizing a near field communications protocol.

21. The apparatus of claim 16, wherein the pairing token is operable to pair the first electronic device and the second electronic device for Bluetooth communications.

22. The apparatus of claim 16, wherein the authorization provider module is further configured to confirm a first electronic device certification authority certificate and a second electronic device certification authority certificate prior to issuing the pairing token.
